(19) United States
(12) Patent Application Publication
(10) Pub. No.: US 2006/0221857 A1
(43) Pub. Date: Oct. 5, 2006

(54) Method and apparatus for providing enhanced features to multicast content services and multiplayer gaming services

(76) Inventors: William J. Bushnell, St. Charles, IL (US); Nicholas M. DeVito, Naperville, IL (US); James C. Wood, Swindon (GB)

Correspondence Address: FAY SHARPE/LUCENT, 1100 SUPERIOR AVE, SEVENTH FLOOR, CLEVELAND, OH, 44114, US

(21) Appl. No.: 11/094,985

(22) Filed: Mar. 31, 2005

(51) Int. Cl. H04L 12/28; H04L 12/56

(52) U.S. Cl. 370/254; 370/390

(57) ABSTRACT

A method and apparatus for providing enhanced features to multicast users is provided. More particularly, this invention describes a mechanism by which the online content or gaming services can invoke full feature VoIP services offered by a third party VoIP telephony service provider and/or initiate related packet communication services such as instant messaging. This simplifies the complexity of the online content or gaming system and provides the end users with a more feature-rich experience.

### BACKGROUND OF THE INVENTION

This invention relates to a method and apparatus for providing enhanced features to interactive sessions such as those involving multicast content services and multiplayer gaming services. More particularly, this invention describes a system by which the multicast content or multiplayer gaming services users can be informed that their friends or associates are also simultaneously viewing the same content or using the same multiplayer gaming service. Furthermore, the end user can invoke IP based text, voice and video communication sessions with the other users. This simplifies the complexity of the online content or gaming system and provides the end users with a more feature-rich experience.

While the invention is particularly directed to the art of packet communication technology used in connection with multiplayer gaming and other content-based services, and will be thus described with specific reference thereto, it will be appreciated that the invention may have usefulness in other fields and applications. For example, the invention may be used where there is a desire to enhance other types of communication sessions using Voice-over-IP and other packet-based communication protocols.

By way of background online multiplayer gaming providers have developed technologies to enhance the interaction between groups of friends or “buddies” as these groups interact with the online content or game session. Frequently, gaming providers add the ability for the end user to learn when buddies are online. This is commonly referred to as “presence” within the online service. This invention extends this concept of presence to multicast content services.

In addition, these online multiplayer gaming systems typically add the ability for the users to easily initiate real time text, voice or video communications with each other while interacting with the online gaming system. The users can communicate with each other using a variety of real time communication services such as Instant Message or VoIP session. The objective of the service providers in providing these communication services to users is to build communities of users which stimulates additional revenue for the service provider. This invention extends this ability to conveniently launch real time communication services to multicast content services.

To provide the VoIP communication service, the online multiplayer gaming providers typically use a peer-to-peer communication architecture which consists of their own basic VoIP clients. These clients must be downloaded to the end users PC or wireless device. Notably, this VoIP client and communication service is separate and distinct from the VoIP client and services that might be provided by a VoIP Telephone Service provider.

There are several disadvantages to this present arrangement. First, the multiplayer gaming communication services can only be used to communicate with buddies when they are engaged in a multiplayer game session. Second, different online multiplayer gaming services may use different VoIP clients. Consequently, a new client must be downloaded for each online service.

Third, because the online VoIP clients operate in a peer-to-peer model, there are no servers in the network to support telephony session to traditional PSTN endpoints. Fourth, online multiplayer gaming service providers do not provide telephone numbers for initiating contact to the subscribers. This would allow buddies to call each other to arrange online events.

Fifth, the online multiplayer gaming VoIP, service typically lack the vertical features that allow users to handle multiple simultaneous VoIP sessions (e.g., Call Waiting, Call Hold, Call Forward on Busy, Voice Mail, Caller ID, three way calling.) If these online multiplayer gaming service providers supported these services, then each online multiplayer gaming service provider would have to replicate the services of a VoIP telephony service provider. Last, the multiplayer gaming VoIP services typically lack the ability to invoke QoS mechanisms in the access and transport packet networks.

The present invention contemplates a new and improved system and technique that resolves the above-referenced difficulties and others.

### SUMMARY OF THE INVENTION

A method and apparatus for providing enhanced features to multicast content services and the multiplayer on line gaming services

In one aspect of the invention the method comprises initiating a multicast session or a multiplayer gaming session by a first user, and determining whether other users are simultaneously viewing the same multicast content or the same multiplayer.

In another aspect of the invention, the method further comprises selectively initiating a communication session by the first user with selected ones of the other users

In another aspect of the invention, initiating a multicast session by first user includes initiating content-based functionality and initiating a packet-based communication service.

In another aspect of the invention the packet-based communication service comprises a voice-over-IP communication session.

In another aspect of the invention, the packet-based communication service comprises an instant messaging session.

In another aspect of the invention, the determining comprises determining contact information for the other users.

In another aspect of the invention, the determining comprises determining presence of the users.

In another aspect of the invention, the determining comprises accessing an active phonebook.

In another aspect of the invention, the providing comprises providing a display list to the first user.

In another aspect of the invention, the display list comprises a listing of the other users and indications as to whether the other users are active in the available services.

In another aspect of the invention, a system comprises a first client device operative to initiate a multicast session by a first user, the multicast session comprising a plurality of available services including communication services, a network device operative to determine whether other users are active relative to the plurality of available services and provide the first user with information on the other users and whether the other users are active relative to the plurality of available services, and, a second client device operative to conduct a communication session by the first user with selective ones of the other users.

In another aspect of the invention, initiating a multicast session by first user includes initiating content-based functionality and initiating a packet-based communication service.

In another aspect of the invention, the packet-based communication service comprises a voice-over-IP communication session.

In another aspect of the invention, the packet-based communication service comprises an instant messaging session.

In another aspect of the invention, the determining comprises determining contact information for the other users.

In another aspect of the invention, the determining comprises determining presence of the users.

In another aspect of the invention, the determining comprises accessing an active phonebook.

In another aspect of the invention, the providing comprises providing a display list to the first user.

In another aspect of the invention, the display list comprises a listing of the other users and indications as to whether the other users are active in the available services.

In another aspect of the invention, a system comprises a client device operative to initiate a multicast session by a first user, the multicast session comprising a plurality of available services including communication services, selectively initiate a communication session by the first user with selective ones of the other users, and conduct the communication session; and, a network architecture operative to determine whether other users are active relative to the plurality of available services and provide the first user with information on the other users and whether the users are active relative to the plurality of available services.

In another aspect of the invention, initiating a multicast session by first user includes initiating content-based functionality and initiating a packet-based communication service.

In another aspect of the invention, the packet-based communication service comprises a voice-over-IP communication session.

In another aspect of the invention, the packet-based communication service comprises an instant messaging session.

In another aspect of the invention, the determining comprises determining contact information for the other users.

In another aspect of the invention, the determining comprises determining presence of the users.

In another aspect of the invention, the determining comprises accessing an active phonebook.

In another aspect of the invention, the providing comprises providing a display list to the first user.

In another aspect of the invention, the display list comprises a listing of the other users and indications as to whether the other users are active in the available services.

In another aspect of the invention, a system and method are applicable to gaming services and functions.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 illustrates an embodiment of the present invention.

FIG. 2 is a flow chart illustrating an embodiment of the present invention.

FIG. 3 illustrates another embodiment of the present invention.

FIG. 4 is a flow chart illustrating an embodiment of the present invention.

FIG. 5 illustrates another embodiment of the present invention.

FIG. 6 is a flow chart illustrating an embodiment of the present invention.

FIG. 7 is an exemplary view of a display of information according to the present invention.

### DETAILED DESCRIPTION OF THE PREFERRED EMBODIMENTS

This invention relates to a system and methods by which users of interactive sessions involving services such as Multicast Content services or Multiplayer Gaming services can be informed that their friends or buddies are simultaneously viewing the same content or using the same multiplayer game services. Furthermore, the user is able to easily invoke full-feature text, voice or video communications services such as Instant Messaging or voice-over-IP (VoIP) services offered by a third party telephony service provider This technique enhances the use of the Multicast Content service or the Multiplayer Gaming services

The embodiments of the present invention described hereafter include one embodiment in which the multicast content service client and the packet-based communication services clients (IM or VoIP) all reside on the same device (e.g., PC, wireless PDA, wireless handset). A second embodiment is described in which the Multicast Content Service Client are housed on a single device (e.g., Set Top Box) and the packet based communication services clients (e.g., IM or VoIP) clients are on another device (e.g., wireless handset, IP Phone). A third embodiment involves the implementation of a gaming service whereas the multiplayer gaming clients are housed in a gaming device and the packet-based communication device is housed in another device (e.g., wireless handset, IP phone). Of course, these are merely example embodiments. Other configurations may be implemented in accord with the objectives of the present invention.

The example scenarios describe the invocation of VoIP and/or instant messaging services. The same approach can be used to invoke other packet-based communication services provided by third parties. These include Push to Talk, Multimedia Messaging, Video Telephony, etc.

In the exemplary techniques implemented using the present invention, a user can specify a list of Multicast Content Service or Multiplayer gaming service buddies. When the user channel surfs multicasting sessions (including those previously mentioned as well as other social computing services, e.g., computing, Blogs, Instant Messaging, sporting events, etc.), a list of buddies watching or engaging the same multicasting session is displayed. If the user is watching a multicast session, such as a telecast of a sporting event, and a buddy joins the multicast session, the user is notified. The user then can select, or click on, an item on a display list corresponding to a buddy and determine the presence and availability of the buddy's Instant Messenger (IM), Push to Talk (PTT) or VoIP clients. The user can also select, or click on, a buddy to launch an Instant Message (IM), Push to talk (PTT) or VoIP session. Similar techniques can be realized in a gaming environment.

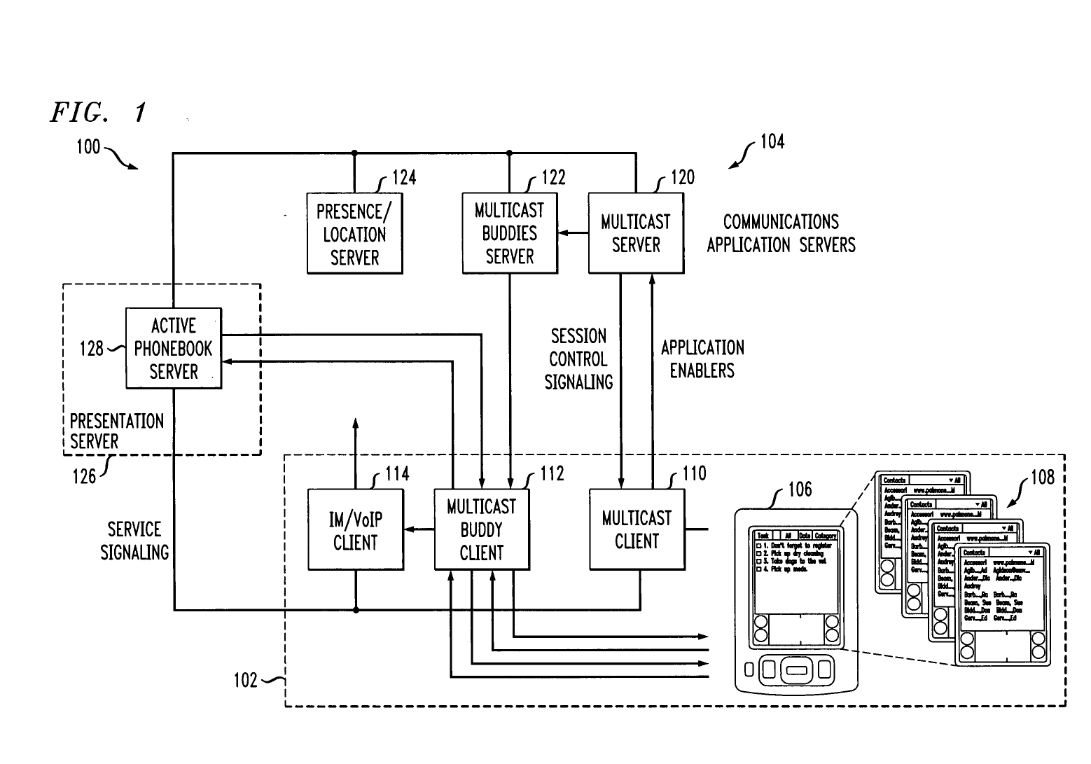

Referring now to the drawings wherein the showings are for purposes of illustrating the preferred embodiments of the invention only and not for purposes of limiting same, FIG. 1 provides a view of a system into which the present invention may be incorporated. As shown, a system 100 includes an end user device 102 and a network 104.

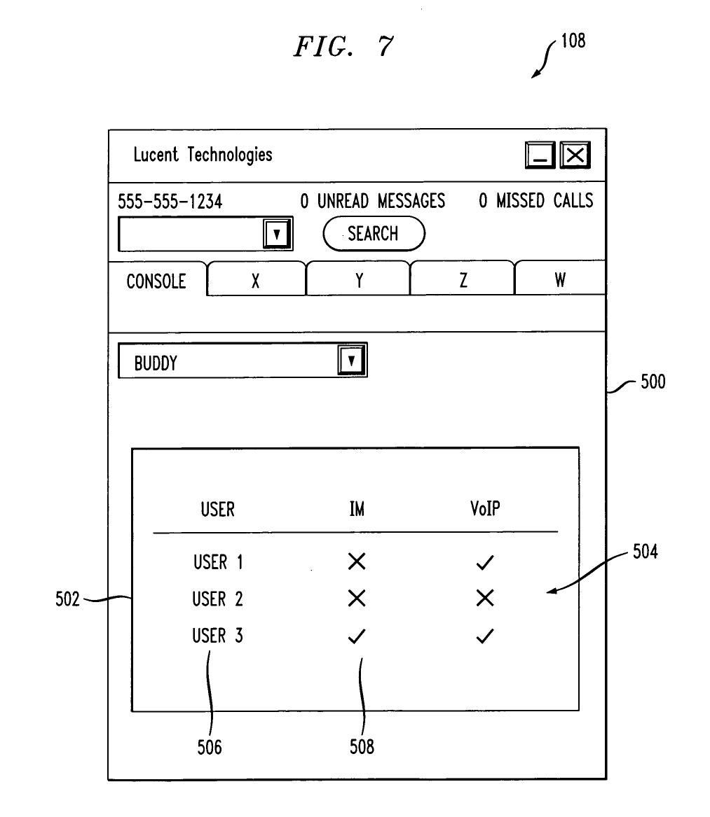

The end user device 102 includes therein a handheld mobile device 106 having a variety of software clients and display lists 108 available to it. The display lists will be described in more detail in connection with FIG. 7. The end user device also includes a multicast client module 110, a multicast buddy client module 112 and an instant messaging (IM)/Voice-over-IP (VoIP) client module 114. It should be appreciated that the end user device 102 may take a variety of forms. For example, it may be a personal digital assistant (PDA), a portable computer, a mobile phone with enhanced capabilities, a personal computer, or the like. It should also be understood that the elements 114, 112 and 110 may take a variety of forms including software modules that reside on the device 102. Of course, it will be understood that these elements are merely represented in logical fashion in FIG. 1. Further, a multicast device such as a television with appropriate set-top box is not shown. However, such a device may also be in communication with the network shown here, assuming the device 106 does not have such functionality.

The network 104 includes a multicast server 120, and a multicast buddy server 122. The network is also provided with a presence/location server 124 and an Active Phonebook Server 128, which may be incorporated as a part of another server such as a presentation server 126.

In this regard, the Active Phonebook Server 128 may be implemented as a database module that stores therein information regarding multicast users. For example, the Active Phonebook Server 128 stores contact information on each of the multicast users. This can be provided to other authorized users at suitable times to allow for communication. Moreover, the Active Phonebook Server 128 stores information on the presence of users relative to various communication services. So, it may store information on whether a particular user subscribes to certain services. Notably, the Active Phonebook Server 128 also stores information on whether users are currently active, or engaged, in communication services. The format for storage of this data within the active phonebook server 128 may vary from application to application.

Populating and updating of the Active Phonebook Server typically occurs when a request is made to the Active Phonebook Server from a user seeking information on its buddies. In this regard, the active phonebook server searches the network through the presence/location server to find the correct status of the buddies relative to various communication services. Of course, these lists comprise users who subscribe to one or more of the services contemplated. There may also be blocking mechanisms available that prevent certain users from accessing information on other users or other user services.

It should also be understood that the elements 120, 122, 124,126 and 128 may take a variety of forms including software modules that reside on various network elements within the network 104. Of course, it will be understood that these elements are merely represented in logical fashion in FIG. 1. In implementation, these modules and/or routines may be housed within a single network element or distributed among a variety of network elements.

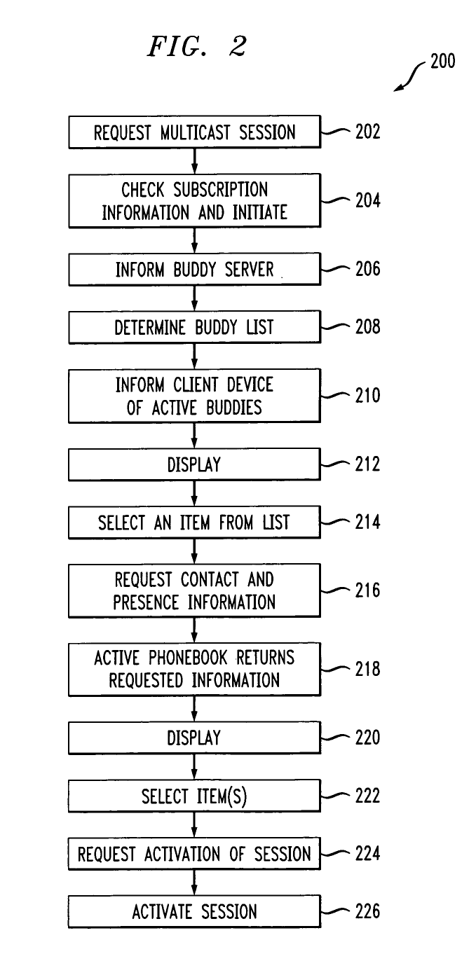

In operation, with reference now to FIG. 2, a method 200 according to the embodiment described in connection with FIG. 1 may be initiated. If so initiated, an end user manipulating the end user device 102 requests a multicasting stream from the multicast server 120 through its multicast client 110 (at 202). The multicast server 120 then checks subscription information and initiates a session (at 204). The multicast server 120 also informs a buddy server 122 of the activity of the user (at 206). In turn, the buddy server 122 determines if other users stored on a buddy list of the user initiating the session are active in the same multicasting sessions (e.g., watching a sporting event) (at 208). The buddy server 122 then informs the end user device 102 of the activity of the buddy viewers (at 210). Of course, this information is displayed to the end user through the end user device 102 via Multicast Buddy Client on the display of the device 106 or other devices such as a television (at 212).

As an option, items on the display are then selected, or clicked on, to request display of the presence, with respect to communication services of the buddy (at 214). The buddy 112 client then sends a request for contact information and presence to the active phonebook server 128 (at 216). The active phonebook server 128 retrieves current status of the selected buddies returns the requested information (at 218). Again, the status is displayed to the end user via the Multicast Buddy Client using display lists 108 (at 220). Based on the current status of the buddy users, the user can select, or click on, items of the display to initiate instant messaging (IM) or Voice-over-IP (VoIP) sessions to communicate with a buddy (at 222). Upon receiving such a request, the Multicast Buddy Client 112 sends a message to the IM or VoIP client (114) that requests that the IM or VoIP session be activated (at 224). Last, the user composes and sends the instant messaging (IM) or Voice-over-IP (VoIP) call through the IM/VoIP client 114 (at 226).

As noted above, the modules that perform the exemplary methods of the embodiments of the present invention may be implemented in a variety of different manners. In addition, suitable messaging and/or signaling techniques will also be implemented to accommodate the functionality of the modules and the elements described herein. These techniques will vary from application to application.

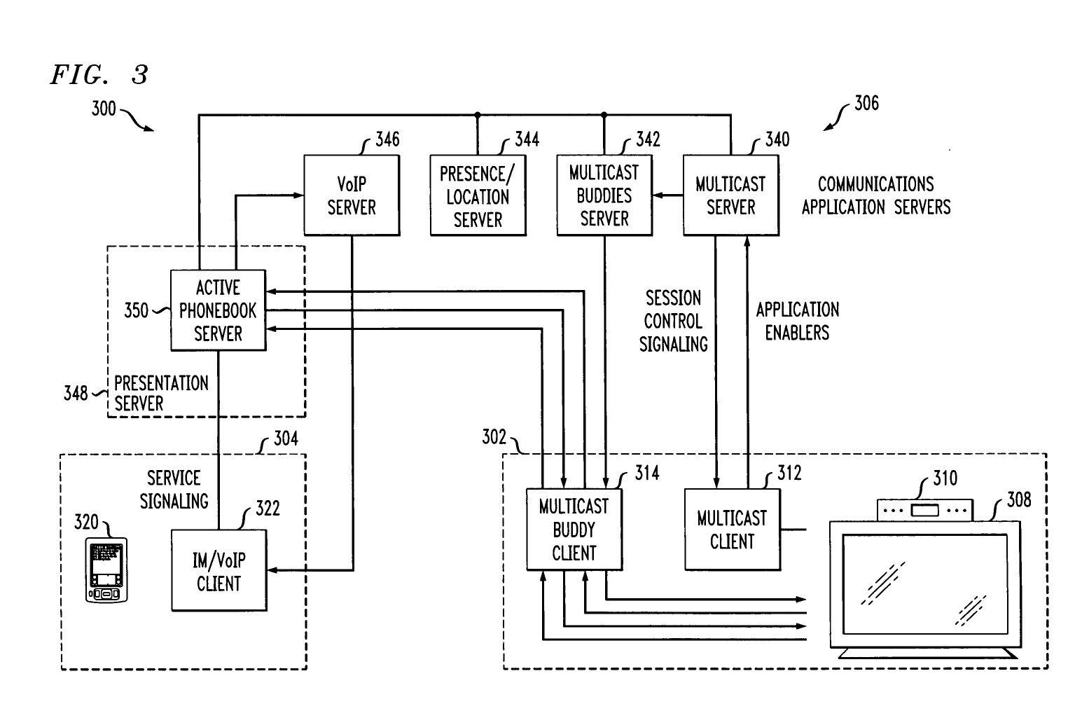

Referring now to FIG. 3, a further embodiment of the present invention is illustrated. This embodiment shows another exemplary scenario wherein the user maintains a first device that is typically wired into the network, such as a display device, and a second device that provides wireless communication services such as instant messaging (IM), Voice-over-IP (VoIP) or other packet-based communication services. As shown, the system 300 includes a first end user device 302 and a second end user device 304. These devices 302 and 304 communicate with a network 306. Of course, as will be apparent, these devices are similar to those discussed in connection with FIG. 1 but are provisioned with the clients in a different manner.

The first end user device 302, in one example, includes a display device 308. The display device may be a television, a computer monitor device or the like. The device 302 also includes a control device 310. The control device 310, in one form, also include a multicast client module 312 and a multicast buddy client module 314. It should be appreciated that the first end user device 302 may take a variety of forms. For example, if a television is used, the control device 310 is preferable as a set top box communication device. If the user display device 302 is a personal computer, the display device 302 may take the form of a monitor and a processor having the communication device 310 incorporated therein. This, of course, is true for the multicast client and the multicast buddy client as well.

The second end user device 304 includes a mobile device 320 having instant messaging (IM) and Voice-over-IP (VOIP) client software modules 322 residing thereon. Of course, it should be appreciated that the mobile device 304 may take a variety of forms, including but not limited to, a mobile phone, a personal digital assistant (PDA), a portable personal computer, a pager or other wireless communication devices.

It should also be understood that the elements 314, 312 and 322 may take a variety of forms including software modules that reside on the respective devices 302 and 304. Of course, it will be understood that these elements are merely represented in logical fashion in FIG. 3.

The network 306 includes a multicast server 340, and a multicast buddy server 342. The network is also provided with a presence/location server 344 and a Voice-over-IP (VoIP) server 346. These network elements communicate with a presentation server 348 which includes an active phonebook server 350.

In this regard, the active phonebook server 350 may be implemented as a database module that stores therein information regarding multicast users. For example, the Active Phonebook Server 350 stores contact information on each of the multicast users. This can be provided to other authorized users at suitable times to allow for communication. Moreover, the Active Phonebook Server 350 stores information on the presence of users relative to various communication services such as IM or VoIP. The format for storage of this data within the active phonebook server may vary from application to application.

Populating and updating of the Active Phonebook Server typically occurs when a request is made to the Active Phonebook Server from a user seeking information on its buddies. In this regard, the active phonebook server searches the network through the presence/location server to find the correct status of the buddies relative to various services. Of course, these lists comprise users who subscribe to one or more of the services contemplated. There may also be blocking mechanisms available that prevent certain users from accessing information on other users or other user services.

It should also be understood that the elements 340, 342, 344, 346, 348 and 350 may take a variety of forms including software modules that reside on various network elements within the network 306. Of course, it will be understood that these elements are merely represented in logical fashion in FIG. 3. In implementation, these modules and/or routines may be housed within a single network element or distributed among a variety of network elements.

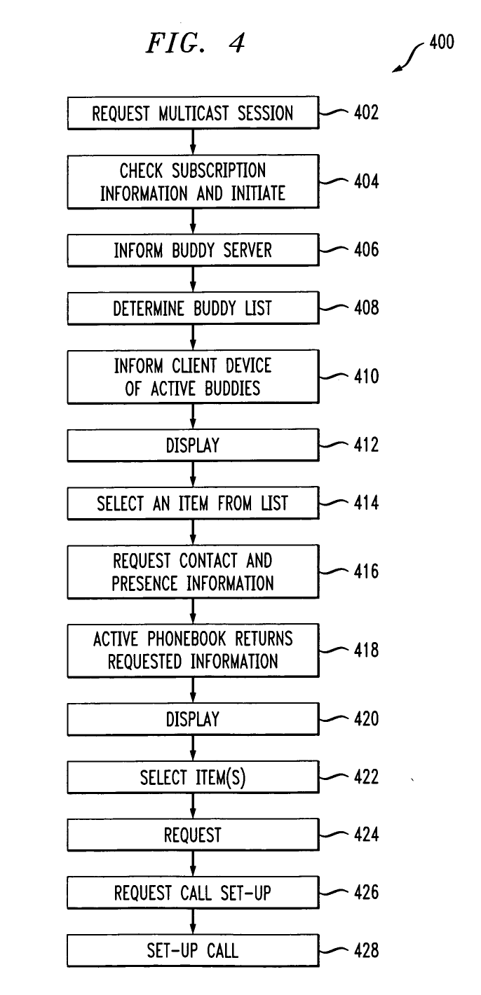

In operation, with reference now to FIG. 4, a method 400 to be implemented in the example network of FIG. 3 is illustrated. In this regard, the method 400 is initiated when the user requests a multicasting stream from the multicast server 340 through the multicast client 312 (at 402). The multicast server 340 then checks subscription data, initiates a session and communicates that to the multicast client 312 (at 404). The multicast server 340 also informs the Multicast Buddy Server 342 of the client activity (at 406). The Multicast Buddy Server 342 then retrieves information on other viewers or users (and their multicasting activity) that reside on the buddy list of the user (at 408). The Multicast Buddy Server 342 informs the user of the members of their buddy list that are viewing the same multicast session e.g., viewers that may be watching a sporting event (at 410). This information is then displayed to the user via the Multicast Buddy Client (314) through a display (not shown) (at 412).

The user may then select, or click on, an item in the display list to display the presence, with respect to communication services, of the activities of the buddy corresponding to the clicked item (at 414). The Multicast Buddy client module 314 then sends a request for contact information and presence status to the Active Phonebdok Server 350 (at 416). The Active Phonebook Server 350 then acts as above and responds with appropriate data (e.g., IM and VoIP status, contact functionality, etc.) (at 418). The status that is received is then displayed to the user via the Multicast Buddy Client (314) (at 420).

As an option, the user then may select, or click on, an item in the display to initiate a Voice-over-IP (VoIP) session or another packet-based communication session (such as an instant messaging session) (at 422). The multicast client module 312 then sends a request to the active phonebook server 350 (at 424). The active phonebook server 350 sends a third party call set-up request to set-up the call to the VoIP Server (346) (at 426). The Voice-over-IP (VoIP) server 346 then sets up the call through the client device 322 (at 428). Of course, as with the configuration of FIG. 1, establishing a communication session is not necessary. In the event that the user does not do so, the information that is received at step 420 may be otherwise used by the user.

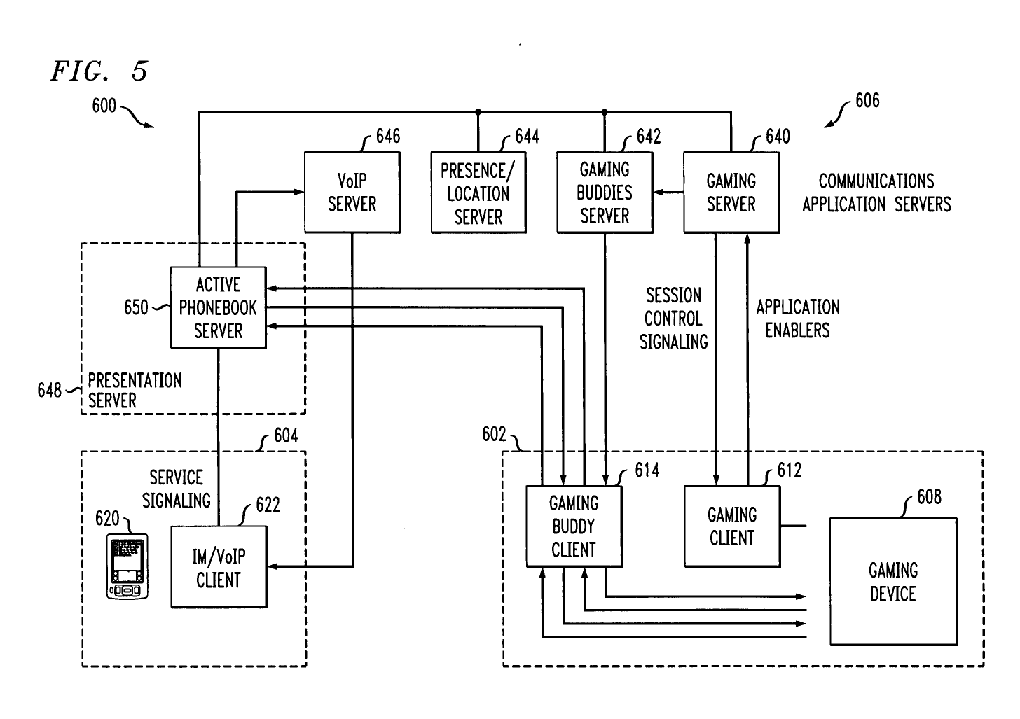

The functionality of the present invention may also be applied to situations where gaming is the primary function. In this regard, with reference to FIG. 5, a network 600 is shown. This embodiment shows another exemplary scenario wherein the user maintains a first device that is connected to the network such as a gaming device and a second device that provides wireless communication service such as instant messaging, Voice-over-IP or other packet-based communication services. As shown, the system 600 includes a first end user device 602 and a second end user device 604. These devices 602 and 604 communicate with the network 606.

The first end user device 602, in one example, includes a gaming device 608. The device 602 also includes a gaming client module 612 and a gaming buddy client module 614. It should be appreciated that the first end user device 602 may take a variety of forms. For example, it may take the form of a dedicated gaming device or of a personal computer having appropriate processing and gaming functions.

The second end user device 604 includes a mobile device 620 having instant messaging (IM) and Voice-over-IP (VOIP) client software module 622 residing thereon. Of course, it should be appreciated that the mobile device 604 may take a variety of forms, including but not limited to, a mobile phone, a personal digital assistant (PDA), a portable personal computer, a pager or other wireless communication devices.

It should also be understood that the elements 614, 612 and 622 may take a variety of forms including software modules that reside on the respective devices 602 and 604. Of course, it will be understood that the elements are merely represented in logical fashion in FIG. 5.

The network 606 includes a gaming server 640 and a multiplayer gaming buddy server 642. The network is also provided with a presence/location, or gaming buddy, server 644 and a Voice-over-IP (VoIP) server 646. These network elements communicate with a presentation server 648 which includes an active phonebook server 650.

In this regard, the active phonebook server may be implemented as a database module that stores therein information regarding gaming users. For example, the active phonebook server 650 stores contact information on each of the users. This can be provided to other authorized users at suitable times to allow for communication. Moreover, the active phonebook server 650 stores information on the presence of users relative to various communication services such as instant messaging or Voice-over-IP. The format of this storage of this data within the active phonebook server may vary from application to application.

Populating and updating the active phonebook server typically occurs when a request is made to the active phonebook server from a user seeking information on its buddies. In this regard, the active phonebook server searches the network through the presence/location server to find the correct status of the buddies relative to various services. Of course, these lists comprise users who subscribe to one or more of the services contemplated. There may also be blocking mechanisms available that prevent certain users from accessing information on other users or other user services.

It should also be understood that element 640, 642, 644, 646, 648 and 650 may take a variety of forms including software modules that reside on various network elements within the network 606. Of course, it will be understood that these elements are merely represented in logical fashion in FIG. 5. In implementation, these modules and/or routines may be housed within a single network element or distributed among a variety of network elements.

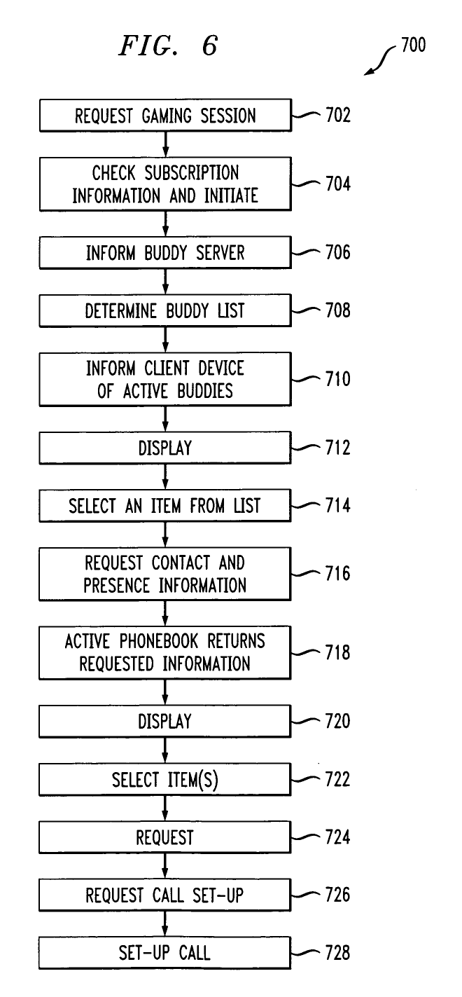

In operation, with reference now to FIG. 6, a method 700 to be implemented in the example network of FIG. 5 is illustrated. In this regard, the method 700 is initiated when the user requests a gaming session from the gaming server 640 through the gaming client 612 (at 702). The gaming server 640 then checks the subscription data, initiates a session and communicates to the gaming client 612 (at 704). The gaming server 640 also informs the buddy server 642 of the client activity (at 706). The buddy server 642 then retrieves information on other viewers or users (and their gaming activity) that reside on the buddy list of the user (at 708). The buddy server 642 informs the user of the gaming activity of the other viewers or users (e.g., viewers that may be gaming) (at 710). This information is then displayed to the user via the gaming buddy client 614 through a display (at 712). The user then may select, or click on an item in the display list to display the presence of the activities of the buddy corresponding to the clicked item (at 714). The buddy client module 614 then sends a request for information and presence status to the active phonebook server 750 (at 716). The active phonebook server 650 then acts as above and responds with appropriate data (e.g., IM and VoIP status, contact functionality, etc.) (at 718). The status that is received is then displayed to the user via the buddy client 614 (at 720).

As an option, the user may then select or click on an item in this display to initiate a Voice-over-IP (VoIP) session or another packet-based communication session such as an instant messaging session (at 722). The gaming client module 612 then send a request to the active phonebook server 650 (at 724). The active phonebook server 650 sends a third party call set-up request to call the Voice-over-IP server 646 (at 726). The Voice-over-IP (VoIP) server 646 then sets up the call through the IM/VoIP client 622 of end user device 604 (at 728).

As noted above, the modules that perform the exemplary methods of the embodiments of the present invention may be implemented in a variety of different manners. In addition, suitable messaging and/or signaling techniques will also be implemented to accommodate the functionality of the modules and the elements described herein. These techniques will vary from application to application.

With reference now to FIG. 7, an example display list or element 108 is illustrated. As an example, display element 500 includes a display area 502. Within the display area 502, the various data entries 504 are illustrated. Each data entry 504 includes at least a name 506 and an activities status 508.

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

We claim:

1. A method for providing multicast sessions to a plurality of users, the: method comprising:
initiating a multicast session by a first user, the multicast session comprising a plurality of available services including communication services;
determining whether other users are active relative to the plurality of available services; and, providing the first user with information on the other users and whether the other users are active relative to the plurality of available services.

2. The method as set forth in claim 2 further comprising selectively initiating a communication session by the first user with selected ones of the other users.

3. The method as set forth in claim 1 wherein initiating a multicast session by first user includes initiating content-based functionality and initiating a packet-based communication service.

4. The method as set forth in claim 3 wherein the packet-based communication service comprises a voice-over-IP communication session.

5. The method as set forth in claim 3 wherein the packet-based communication service comprises an instant messaging session.

6. The method as set forth in claim 1 wherein the determining comprises determining contact information for the other users.

7. The method as set forth in claim 1 wherein the determining comprises determining presence of the users.

8. The method as set forth in claim 1 wherein the determining comprises accessing an active phonebook.

9. The method as set forth in claim 1 wherein the providing comprises providing a display list to the first user.

10. The method as set forth in claim 9 wherein the display list comprises a listing of the other users and indications as to whether the other users are active in the available services.

11. A system for providing multicast sessions to a plurality of users, the system comprising:
a first client device operative to initiate a multicast session by a first user, the multicast session comprising a plurality of available services including communication services;
a network device operative to determine whether other users are active relative to the plurality of available services and provide the first user with information on the other users and whether the other users are active relative to the plurality of available services; and, a second client device operative to conduct a communication session by the first user with selective ones of the other users.

12. The system as set forth in claim 11 wherein initiating a multicast session by first user includes initiating content-based functionality and initiating a packet-based communication service.

13. The system as set forth in claim 12 wherein the packet-based communication service comprises a voice-over-IP communication session.

14. The system as set forth in claim 12 wherein the packet-based communication service comprises an instant messaging session.

15. The system as set forth in claim 11 wherein the determining comprises determining contact information for the other users.

16. The system as set forth in claim 11 wherein the determining comprises determining presence of the users.

17. The system as set forth in claim 11 wherein the determining comprises accessing an active phonebook.

18. The system as set forth in claim 11 wherein the providing comprises providing a display list to the first user.

19. The system as set forth in claim 18 wherein the display list comprises a listing of the other users and indications as to whether the other users are active in the available services.

20. A system for providing interactive sessions to a plurality of users, the system comprising:
an end user device operative to initiate a session by a first user, the session comprising a plurality of available services including communication services, selectively initiate a communication session by the first user with selective ones of other users, and conduct the communication session; and,
a network architecture operative to determine whether the other users are active relative to the plurality of available services and provide the first user with information on the other users and whether the users are active relative to the plurality of available services.

21. The system as set forth in claim 20 wherein initiating a session by first user includes initiating content-based functionality and initiating a packet-based communication service.

22. The system as set forth in claim 21 wherein the packet-based communication service comprises a voice-over-IP communication session.

23. The system as set forth in claim 21 wherein the packet-based communication service comprises an instant messaging session.

24. The system as set forth in claim 20 wherein the determining comprises determining contact information for the other users.

25. The system as set forth in claim 20 wherein the determining comprises determining presence of the users.

26. The system as set forth in claim 20 wherein the determining comprises accessing an active phonebook.

27. The system as set forth in claim 20 wherein the providing comprises providing a display list to the first user.

28. The system as set forth in claim 27 wherein the display list comprises a listing of the other users and indications as to whether the other users are active in the available services.

29. A system for providing gaming sessions to a plurality of users, the system comprising:
a first client device operative to initiate a gaming session by a first user;
a network device operative to determine whether other users are active relative to gaming services and provide the first user with information on the other users and whether the other users are active relative to the plurality of gaming services; and,
a second client device operative to conduct a communication session by the first user with selective ones of the other users through a communication client.
